(19) United States
(12) Patent Application Publication
(10) Pub. No.: US 2004/0015813 A1
(43) Pub. Date: Jan. 22, 2004

(54) Method and system for multi-scenario interactive competitive and non-competitive training, learning, and entertainment using a software simulator

(75) Inventor: Moshe Yerushalmy, Nirit (IL)

Correspondence Address: DR. MARK FRIEDMAN LTD., c/o Bill Polkinghorn, Discovery Dispatch, 9003 Florin Way, Upper Marlboro, MD, 20772, US

(73) Assignee: MBE SIMULATIONS LTD.

(21) Appl. No.: 10/077,821

(22) Filed: Feb. 20, 2002

Related U.S. Application Data
(60) Provisional application No. 60/270,208, filed on Feb. 22, 2001.

(51) Int. Cl. G06F 9/44

(52) U.S. Cl. 717/100

(57) ABSTRACT

A system for interactive training, learning, and entertainment. The system includes a user operable data processing and display device designed and configured to operate a software simulator. The software generates, and simulates operation of, at least one organization. The system further includes a database containing data for operation of the software. According to the system, operation the organization is in response to data supplied to the database by a user. Further disclosed is a method for interactive training, learning, and entertainment including providing data from a database to a software simulator which simulates operation of at least one simulated organization to generate a first event which requires input of a first response. The method further includes receiving the input first response to the database and providing additional data from the database in order to generate a second event which requires input of a second response. According to the method, the input first response determines which additional data is chosen by the software simulator. The method further includes recording recording the first and second responses of a user in the database for subsequent analysis.

### FIELD AND BACKGROUND OF THE INVENTION

The present invention relates to software simulators used for training, learning, and entertainment and, more particularly, to a method and system for multi-scenario interactive competitive and non-competitive training, learning, and entertainment, using a software simulator featuring multi-scenario interactive competitive and non-competitive dynamics. Hereinafter, the phrases ‘competitive and non-competitive’, and, ‘competitively and non-competitively’ are also referred to as ‘competitive/non-competitive’, and, ‘competitively/non-competitively’, respectively.

Three main alternative categories of multi-scenario interactive competitive/non-competitive dynamics are used for implementing the present invention: (1) a single user interactively and competitively/non-competitively operating a simulated organization in a simulated environment characterized and affected by a set of simulated dynamically changing market or supply/demand parameters, (2) a plurality of users interactively and competitively/non-competitively operating a corresponding plurality of simulated organizations in a same simulated environment characterized and affected by a same set of simulated dynamically changing market or supply/demand parameters, and, (3) a first plurality of users interactively and competitively/non-competitively operating a corresponding first plurality of simulated organizations, and, a second plurality of users interactively and competitively/non-competitively operating a corresponding second plurality of simulated organizations, where the first plurality of users and the second plurality of users interactively and competitively/non-competitively operate in a same simulated environment characterized and affected by a same set of simulated dynamically changing market or supply/demand parameters.

Two recent examples of a system, method, and software simulator for goal based education are disclosed in U.S. Pat. No. 6,125,358, issued to Hubbell et al., and in U.S. Pat. No. 6,003,021, issued to Zadik et al., both assigned to the same assignee. In theses disclosures there is no description or suggestion for incorporating multi-scenario interactive competitive dynamics for implementing the disclosed inventions. In particular, there is no description or suggestion whereby users compete against one another. More specifically, there is no description for relating or incorporating changing supply and/or demand parameters associated with changes in products and/or customers, into user implementation of the disclosed simulated business environments. Additionally, the simulators of these disclosures have no function for a user to periodically and/or spontaneously pause real time operation of a simulated business environment, for example, during any user selected minute on a minute-by-minute real time simulated operating basis, for the purpose of periodically spontaneously analyzing and reviewing scenario parameters affecting the simulated business environment up to that selected minute.

These lacking features of ‘realism’ in the above disclosed simulated environments are significant fundamental limitations with respect to implementing a software simulator for effectively and realistically educating ‘real’ users living and functioning in ‘real’ world environments, be they business, entertainment, or any other types of real world environments which inevitably include and are affected by interactive and dynamically changing competitive factors and parameters.

To one of ordinary skill in the art, there is thus a need for, and it would be useful to have a method and system for multi-scenario interactive competitive and non-competitive training, learning, and entertainment, using a software simulator featuring multi-scenario interactive competitive and non-competitive dynamics. Moreover, there is thus a need for, and it would be useful to have such an invention which is implemented by applying different categories of multi-scenario interactive competitive and non-competitive dynamics for creating different types of training, learning, and entertainment environments including and affected by interactively dynamically changing market or supply/demand parameters associated with products and customers. Furthermore, there is a need for such an invention which is implemented in either a non-network environment or in a network environment.

### SUMMARY OF THE INVENTION

According to one aspect of the present invention there is provided a system for multi-scenario interactive training, learning, and entertainment, the system includes: (a) at least one user operating at least one data processing and display device designed and configured to operate a software simulator which simulates operation of at least one simulated organization generated by the software simulator; and (b) a database containing data and information associated with operating the software simulator. Operation of at least one of the at least one simulated organization is in response to data supplied to the database by the at least one user.

According to another aspect of the present invention there is provided a method for multi-scenario interactive training, learning, and entertainment, the method includes: (a) providing data from a database to a software simulator which simulates operation of at least one simulated organization generated by the software simulator in order to generate a first event which requires a first response; (b) allowing at least one user operating at least one data processing and display device designed and configured to operate the software simulator to input the first response to the database; (c) providing additional data from the database to the software simulator in order to generate a second event which requires a second response; and (d) recording the first and second responses of the at least one user in the database for analysis. According to this aspect of the invention, the first response determines which additional data is chosen by the software simulator.

According to further features in preferred embodiments of the invention described below, the system further includes: (c) a remote server capable of communication with the at least one data processing and display device; and (d) a channel of communication capable of facilitating data transfer between the server and the at least one data processing and display device.

According to still further features in the described preferred embodiments the channel of communication includes at least one item selected from the group consisting of a telephone connection, a cellular telephone connection, an Internet connection, an infrared frequency transmission connection, a local area network connection, a radio frequency connection, a fiber-optic connection or a connection by a wire

According to still further features in the described preferred embodiments the database includes data used by the software simulator in generation of multi-scenario interactive dynamics for training, learning and entertainment.

According to still further features in the described preferred embodiments the at least one user includes at least two users, each of the at least two users operating the software simulator interactively.

According to still further features in the described preferred embodiments operating the software simulator interactively indicates competition among the at least two users.

According to still further features in the described preferred embodiments the at least two users are interactively connected and allowed to engage in an industry level of cooperation according to rules and conventions of business.

According to still further features in the described preferred embodiments the cooperation includes at least one item selected from the group consisting of business-to-business (B2B) and business-to-customer (B2C) relationships.

According to still further features in the described preferred embodiments the software simulator is further designed and configured to provide each of the at least one user with at least one item selected from the group consisting of information items relevant to a decision selected from a list, information items relevant to a topic selected from a list and available decisions.

According to still further features in the described preferred embodiments the software simulator is further designed and configured to generate events from data in the database.

According to still further features in the described preferred embodiments the software simulator is further designed and configured to generate scenarios from data in the database.

According to still further features in the described preferred embodiments the software simulator is further designed and configured to provide active guidance for the user. This guidance serves to direct the user towards improved performance. The guidance is based upon data supplied to the database by the user and results of that data on the simulated environment.

According to still further features in the described preferred embodiments the software simulator is further designed and configured to generate summaries of results of data input to the database by the at least one user.

According to still further features in the described preferred embodiments the software simulator is further designed and configured to generate a history of data and information relating to data input to the database by the at least one user in a format selected from the group consisting of a tabular format and a graphical format.

According to still further features in the described preferred embodiments the software simulator is further designed and configured to save simulation sessions as files and, optionally, to replay the files.

According to still further features in the described preferred embodiments the software simulator is further designed and configured to compare at least two of the files.

According to still further features in the described preferred embodiments the database resides in a location selected from the group consisting of the at least one data processing and display device, the remote server and a combination thereof.

According to still further features in the described preferred embodiments the method further includes: (e) analyzing the responses in the database as a means of assessing managerial skills of the user.

According to still further features in the described preferred embodiments the method further includes cyclic repletion of steps a-d.

According to still further features in the described preferred embodiments the method further includes: (e) transferring data between a remote server containing at least a portion of the database and the at least one data processing and display device.

According to still further features in the described preferred embodiments providing data includes concurrent provision of data from the database to a software simulator which simulates operation of a plurality of simulated organizations. This provision of data generates a first event which requires a first response from a plurality of users operating a plurality of data processing and display devices. As a result, the plurality of users concurrently participates in simulated events.

According to still further features in the described preferred embodiments the method, the plurality of users operating the plurality of data processing and display devices engage in active competition.

According to still further features in the described preferred embodiments the method further includes providing to each of the plurality of users, access to responses accumulated in the database. This allows users to see how other users have responded.

According to still further features in the described preferred embodiments the method further includes: (e) monitoring of the responses of the at least one user and a performance of the simulated organization by the software simulator; (f) generating at least one recommendation to aid the at least one user in achieving a goal; and (g) providing the at least one recommendation to the user.

According to still further features in the described preferred embodiments each of the plurality of users is capable of communicating with any other members of the plurality directly. Such communication may occur, for example, via a chat room or a virtual community.

The present invention relates to a method and system for multi-scenario interactive competitive and non-competitive training, learning, and entertainment, using a software simulator featuring multi-scenario interactive competitive and non-competitive dynamics. Three main alternative categories of multi-scenario interactive competitive/non-competitive dynamics are used for implementing the invention: (1) a single user interactively and competitively/non-competitively operating a simulated organization in a simulated environment characterized and affected by a set of simulated dynamically changing market or supply/demand parameters, (2) a plurality of users interactively and competitively/non-competitively operating a corresponding plurality of simulated organizations in a same simulated environment characterized and affected by a same set of simulated dynamically changing market or supply/demand parameters, and, (3) a first plurality of users interactively and competitively/non-competitively operating a corresponding first plurality of simulated organizations, and, a second plurality of users interactively and competitively/non-competitively operating a corresponding second plurality of simulated organizations, where the first plurality of users and the second plurality of users interactively and competitively/non-competitively operate in a same simulated environment characterized and affected by a same set of simulated dynamically changing market or supply/demand parameters. The present invention is implemented in either a non-network environment, such as that featuring at least one PC locally operated by at least one user, or, in a network environment, such as that featuring a plurality of PCs locally and/or non-locally operated by a plurality of users, interactively communicating with each other, and preferably, interactively communicating with a network service provider hosting, overseeing, and maintaining, the software simulator and a server based database for the plurality of users, by way of an intranet or an extranet.

Thus, according to the present invention, there is provided a method for multi-scenario interactive competitive and non-competitive training, learning, and entertainment, using a software simulator, the method comprising the steps of: (a) preparing the software simulator with multi-scenario interactive competitive and non-competitive dynamics for the training, learning, and entertainment, to at least one user; (b) activating, either locally off-line, or, on-line, the software simulator by the at least one user; (c) operating a simulated organization by the at least one user on a continuous basis; (d) initializing scenario events by the software simulator for generating various types of events which are used for the training, learning, entertainment, and for evolving scenarios; (e) generating the scenario events and directions for the training, learning, and entertainment, by an interactive and competitive/non-competitive simulated environment according to at least one of particular categories of the multi-scenario interactive competitive/non-competitive dynamics; (f) responding to the generated scenario events by each simulated organization and by the at least one user; (g) searching for correct information, correct decisions, and/or purchasing consultation, followed by responding, by the at least one user; (h) recording events into a database by the software simulator for replaying at a later time; (i) recording user performance and all other relevant data and information in the appropriate databases, whereby the at least one user has access to the recorded user performance and the other relevant data and information; and (j) monitoring responses of the at least one user and performance of each simulated organization by a conditional event generator of the software simulator, whereby the conditional event generator generates recommendations for directions the at least one user according to pre-determined goals and schedule of a given simulation session.

According to another aspect of the present invention, there is provided a system for multi-scenario interactive competitive and non-competitive training, learning, and entertainment, using a software simulator, the system comprising: (a) the software simulator featuring multi-scenario interactive competitive and non-competitive dynamics for the training, learning, and entertainment in a multi-user network environment; (b) a plurality of at least two users for interactively and competitively/non-competitively operating a corresponding plurality of at least two simulated organizations generated by the software simulator in the multi-user network environment; (c) a corresponding plurality of computerized processing and display devices for locally hosting and operating the software simulator and for a corresponding plurality of the at least two users to operate the software simulator in the multi-user network environment; (d) a database unit associated with each computerized processing unit, featuring at least one database for locally hosting and saving different types of interactive, non-interactive, static, and/or dynamic, data and information associated with operating the software simulator; (e) a service provider including a server for providing and hosting the software simulator for the plurality of at least two users interactively and competitively/non-competitively operating a corresponding plurality of at least two simulated organizations generated by the software simulator in the multi-user network environment; and (f) an electronic interactive multi-user communication network as a mechanism for the users, the computerized processing and display devices, the database units, and the service provider to interactively communicate with each other.

The present invention successfully addresses the shortcomings of presently known methods and systems for using software simulators for training, learning, and entertainment by effectively and realistically engaging ‘real’ users living and functioning in ‘real’ environments, with simulated environments which include and are affected by interactively and dynamically changing competitive and noncompetitive factors and parameters.

Implementation of the present invention involves performing or completing selected activities, tasks, and/or steps manually, automatically, or a combination thereof. Moreover, according to actual instrumentation and equipment of a particular embodiment of the present invention, several selected steps of the present invention could be implemented by hardware or by software on any operating system of any firmware or a combination thereof. For example, as hardware, selected steps of the invention could be implemented as a computer chip or an electronic circuit. As software, selected steps of the invention could be implemented as a plurality of software instructions being executed by a computer using any suitable operating system. In any case, selected steps of the present invention could be described as being performed by a data processor, such as a computing platform for executing a plurality of instructions.

### BRIEF DESCRIPTION OF THE DRAWINGS

The invention is herein described, by way of example only, with reference to the accompanying drawings, wherein:

FIG. 1 is a schematic diagram illustrating exemplary preferred embodiments of the system for multi-scenario interactive competitive and noncompetitive training, learning, and entertainment, using a software simulator featuring multi-scenario interactive competitive and non-competitive dynamics, in a single or multi-user, non-network or network environment, in accordance with the present invention;

FIG. 2 is a graphical print-out of an exemplary preferred embodiment of a display screen showing various functions a user can select from for making various decisions and for checking relevant information related to the made decisions, by using the software simulator featuring multi-scenario interactive competitive and non-competitive dynamics for training, learning, and entertainment, as part of the system of the present invention shown in FIG. 1, in accordance with the present invention; and

FIGS. 3 and 4 are schematic diagrams illustrating and highlighting exemplary preferred embodiments of the components, elements, and flow, of the multi-scenario interactive competitive and non-competitive dynamics, as part of the software simulator featuring multi-scenario interactive competitive and noncompetitive dynamics for training, learning, and entertainment, as part of the system of the present invention shown in FIG. 1, in accordance with the present invention.

### DESCRIPTION OF THE PREFERRED EMBODIMENTS

The present invention relates to a method and system for multi-scenario interactive competitive and non-competitive training, learning, and entertainment, using a software simulator featuring multi-scenario interactive competitive and non-competitive dynamics. As previously indicated above, the phrases ‘competitive and non-competitive’, and, ‘competitively and non-competitively’ are also referred to as ‘competitive/non-competitive’, and, ‘competitively/noncompetitively’, respectively.

Three main alternative categories of multi-scenario interactive competitive/non-competitive dynamics are used for implementing the invention: (1) a single user interactively and competitively/non-competitively operating a simulated organization in a simulated environment characterized and affected by a set of simulated dynamically changing market or supply/demand parameters, (2) a plurality of users interactively and competitively/non-competitively operating a corresponding plurality of simulated organizations in a same simulated environment characterized and affected by a same set of simulated dynamically changing market or supply/demand parameters, and, (3) a first plurality of users interactively and competitively/non-competitively operating a corresponding first plurality of simulated organizations, and, a second plurality of users interactively and competitively/non-competitively operating a corresponding second plurality of simulated organizations, where the first plurality of users and the second plurality of users interactively and competitively/non-competitively operate in a same simulated environment characterized and affected by a same set of simulated dynamically changing market or supply/demand parameters. Each set of interactively dynamically changing market or supply/demand parameters includes and/or is associated with the simulated organizations, and, products and customers of the simulated organizations.

Accordingly, in each of the above three exemplary categories, (1), (2), and (3), the multi-scenario interactive competitive/non-competitive dynamics feature a simulated environment characterized and affected by interactively dynamically changing market or supply/demand parameters including and/or associated with simulated organizations, and, products and customers of the simulated organizations. Moreover, the present invention is implemented in either a non-network environment, such as that featuring at least one PC locally operated by at least one user, or, in a network environment, such as that featuring a plurality of PCs locally and/or non-locally operated by a plurality of users, interactively communicating with each other by way of an intranet or an extranet, and preferably, interactively communicating with a network service provider hosting, overseeing, and maintaining, the software simulator and a server based database for the plurality of users, by way of the intranet or an extranet.

The main general aspect of novelty of the present invention involves effectively and realistically engaging one or more users with different categories of multi-scenario interactive competitive dynamics for creating different types of training, learning, and entertainment environments including and affected by interactively dynamically changing market or supply/demand parameters associated with simulated organizations, and, products and customers of the simulated organizations.

The present invention provides an effective, stimulating, and real self-training platform that has the look and feel of the real world in operation. The present invention includes a preferred embodiment for implementing in a multi-user network environment, for example, where users interactively communicate with other users by way of a company intranet, a company extranet, or, by way of the public world wide web Internet. In such a multi-user network environment, users interactively compete among themselves, chat, talk, ask for real help, and share solutions and best practices.

The present invention teaches and demonstrates invention features to users while ‘on the training, learning, or entertainment, cycle’, rather than requiring users to spend time learning from exhausting tutorials before starting to implement the invention, in general, and before activating and operating the software simulator, in particular.

The software simulator guides users in the right directions needed for learning and putting to practice things learned, by enabling users to gain real experience, such as in real managerial life, be it for business or pleasure, and, also by providing users with right directions leading to best practices.

The engine of the simulator reacts to multi-parametric input by a user and of generated events, and reacts to performance measures or factors calculated and evaluated by the simulator, for directing users in a (right or wrong) direction.

The simulator records all decisions and events of real time running training sessions so that each user is able to send this record to other users, for example, by operating a replay command.

In a multi-user network environment, operating skills of users are tested and compared to the achievements of other users within a same user type group.

Various situations featuring different levels or tiers of multi-scenario interactive competitive/non-competitive dynamics for training, learning, and entertaining, are simulated by experienced users by applying relatively simple simulator tools and interfacing commands which help the users describe and/or relate to real world situations associated with the real (not simulated) multi-scenario interactive competitive/non-competitive dynamics.

Various particular features of the present invention are described herein as follows:

Real time interactive and competitive/non-competitive user operation: The simulator simulates multi-scenario interactive competitive/non-competitive dynamics of a simulated environment characterized and affected by interactively dynamically changing market or supply/demand parameters including and/or associated with simulated organizations, and, products and customers of the simulated organizations. In addition to the simulated organization interactively and competitively/non-competitively operated by each user, the simulator simulates additional organizations, for example, competitor and/or non-competitor organizations, contributing to the interactive and competitive/noncompetitive simulated environment. Such competitor and non-competitor organizations affect and influence user actions, user decisions, and consequently, results obtained from implementation of user actions and user decisions. For example, there are simulated supplier organizations supplying products to simulated end product organizations, whereby the simulated supplier organization does not compete with the simulated end product organizations, but, clearly, they compete with other simulated supplier organizations supplying the same products to the simulated end product organizations.

Real time interactive and competitive/non-competitive user operation is performed by the simulator in either a non-network environment, such as that featuring at least one PC locally operated by at least one user, or, in a network environment, such as that featuring a plurality of PCs locally and/or non-locally operated by a plurality of users, interactively communicating with each other by way of an intranet or an extranet, for example, where users interactively communicate with other users by way of a company intranet, a company extranet, or, by way of the public world wide web Internet.

E-biz competition: Based on a network environment, a preferred embodiment of the present invention features interactively connecting a plurality of copies of the simulator operated by a corresponding plurality of users, by way of a network, thereby representing an industry level cooperation of simulated supply chain organizations each operating according to rules and conventions of real e-business type organizations. The simulator incorporates business-to-business (B2B) and business-to-customer (B2C) relationships in the simulated environments.

On the training, learning, or entertainment, cycle: Users interactively and competitively operate while ‘on the training, learning, or entertainment, cycle’. Users are trained, taught, and/or entertained with topics as they arise while operating the simulated organizations. Instead of explaining all parameters, decisions, and features, of the simulator at the beginning of a session, attention of each user is focused on issues and problems occurring during simulation and an event monitoring feature trains. The simulator trains and teaches each user about the meaning, issues, and problems associated with each topic.

Topic related information and decisions: The simulator provides each user with information and suitable decisions items relevant to a selected business or management topic. A utility of the simulator helps each user find related information by presenting to the user pre-defined or generated topics suitable for daily situation management and for analyzing each situation. Each user selects a topic, for example, ‘lack of material’, or ‘capacity problem’, among a wide variety of different topics, which describes the current situation of the user operated simulated organization. A menu is displayed which shows information items and suitable decisions which are relevant to each selected topic. Using this information helps the user analyze a situation, obtain relevant information in a short period of time, reduce the need to first learn what is available, and then make decisions from the related decision list in-order to manage the simulated organization along with taking appropriate steps and making appropriate decisions.

Event generation: The simulator simulates events that are close to reality in business and management affected by uncertainties in life. Events are generated according to multi-scenario interactive competitive/non-competitive dynamics of the user operated simulated organization which is affected by a set of dynamically changing market or supply/demand parameters. For example, product cost, product price, inventory level, and product demand by customers, of the simulated organization operating in a simulated environment are dynamically changed in the background during simulation sessions, thereby causing various, sometimes unexpected, situations, which each user must react to. Particular dynamic changes of the simulated environment are defined in an event script file and are processed by the simulator.

Scenario builder: The simulator builds new scenarios or modifies existing ones for creating a new organizational model by operating with a user-friendly interface. The simulator specifies structure and behavior of such a new organization by using a WYSIWYG (What You See Is What You Get) type of ‘user-friendly’ interface.

Tuning simulation session speed: The simulator features user commands for dynamically changing the speed or rate of a continuously running simulation session clock.

Decision related information: The simulator provides each user with information, in run time, relating to each decision the user is willing to try. Each decision has its own related information items which are displayed when the user chooses to make the decision. Activating one of these decisions causes display of relevant information which helps each user analyze the current situation of the organization, to decide whether the user really needs to make the decision, and to what degree or extent the user needs to set the various decision parameters.

Time limitations for problem solving: The simulator provides realistic time limitations and constraints during decision processes of each user.

Objective assessment of managerial knowledge and experience: The simulator is applied in the real world to objectively assess users as potential candidates for management positions in real organizations, and for managerial experience. During the testing, potential candidates must operate and manage the simulated organization and attempt to achieve one or more defined goals in a given scenario of the simulated environment. This includes testing and analyzing real time interactive and managerial skills of the potential candidates.

Real time monitoring and assessment of user decisions and operating performance: The simulator monitors the users response' (for example, retrieval of information, navigation among the various simulated organization's departments, a decision etc.), the response time since an event or alert was presented to the user, consequences and results on the operation of the simulated organization reflected in the simulated organization's records, (for example, cash flow, inventory levels, and service levels) and the achievement of predefined goals. The simulator generates questions related to the user response and results or outcome thereof, and stores the user's answers. The simulator then analyzes the user managerial skills performance and generates a list of all simulated and user responses and answers in the time frame, for further psychological analysis.

Assessing users through a non-localized network: Specially designated or pre-arranged time limited simulation sessions, monitored and recorded by way of a non-localized network such as the Internet, are used for assessing users in a relative (i.e. competitive) fashion. Testing results are stored in the network, for example, in a server of a network service provider, whereby simulation sessions are also replayed for the same and/or for other users.

Simulated instructions and guides: The simulator guides a self-trained user in the direction for improving user performance based on managerial decisions made by the user and business results attained by the user. Various conditions are pre-defined in a file that generates and catches events occurring during simulation. When a condition becomes fulfilled, a pre-defined block of commands is activated. According to activation of particular commands, the simulator displays appropriate explanations, hints, and/or recommendations for each user to execute further decisions.

Consultation purchasing: The simulator helps each user to identify needs for in-depth training and learning, and features the option of purchasing event related consultation. This consultation feature is used by each user for analyzing the current situation of the simulated organization and learning how best to continue operating the organization. Purchased consultations are delivered by applying various mechanisms such as by the self running software of the simulator, by chat, by videotape, or, by an actual live person communicating live with the user by phone or by video.

Chat and community: In a network environment, simulator users interactively communicate with each other, for sharing opinions about details and aspects of the simulator program, in general, and about program scenarios, in particular, by using this built-in feature of the simulator program. The simulator program continuously communicates with a server side application, which is responsible for managing chat sessions of users interactively communicating online among themselves.

Active tabular and/or graphical display of user input and resulting parameters and measurements: The simulator actively displays user input and resulting parameters and measurements, for example, profit, cash, and sales, of the simulated organization, for each user to view and monitor during a session. Users make a scorecard selection of data and information relating to user decisions as a function of time, which, according to interactive (mouse) commands of each user, are then displayed in tabular and/or in graphical format.

Reporting summaries of results: The simulator generates reports of summaries of results for describing training, learning, and/or entertainment summaries of each user in a simulation session, according to particular levels, types, or situations, associated with the session. Reports are generated from a session history database. In a typical session level or situation, a report includes initial data and information about the simulated organization before starting the simulation. Then, the simulator generates a report including the decisions, trials, and end results which took place during each simulation run or session. Each user can review the training, learning, and/or entertainment, path in order to understand achievements and end results obtained by the user. In a situation-decision level, when a situation occurs, the simulator analyzes and generates several alternative event related decisions for each user to select from. The result summary report describes and features data and information associated with these situations, in particular, the possible and selected decisions, and the effects these decisions have on the simulated environment, throughout the simulated sessions.

Histories of tabular and graphical data and information: The simulator compiles and stores tabular and graphical data and information for helping each user to compare and analyze current and previous simulation data and information, especially relating to the multi-parametric input data and information associated with user decisions and associated with events, and corresponding results obtained there from. Data and information generated during each simulation session are saved at the end of each session to a history file. For real time or later separate viewing, a user simply selects a particular history file from a drop-down list in a history or measurement screen.

Saving of simulation sessions as run or executable files: The simulator saves simulation session history as run or executable files, which are later replayed by users. Session history executable files contain all decisions, simulator and/or user generated, exactly as the originally run simulation session, for users to separately review and analyze.

Comparing two simulated runs: The simulator displays, and saves in a file, data and information, at the decision level, of at least two previously run simulation sessions, in a comparative format. Displayed and saved data and information include all user decisions made during each simulation session, and, global measurement values generated at the end of each simulation session.

Managerial knowledge management: The simulator models concrete problems of specific scenarios occurring in real organizations for the purpose of retaining knowledge, constant collaboration, and sharing, of best practices of how such problems were solved and how users can avoid such problems. The simulator fine-tunes and sets initial parameters of scenarios for each simulation session by using a ‘Build’ utility. These specific scenarios of the operating organizations are used for analyzing user progress as part of the training, learning, and entertainment of each user, and resulting data and information is retained in the form of knowledge for later use.

Soft skills: The simulator is used for training, learning, and entertainment, with respect to user soft skills in a realistically simulated environment. Event generating and event monitoring functions and commands are executed by the simulator while recording user reactions and decisions.

The simulator includes functions for users to periodically and/or spontaneously pause real time operation of the simulated organizations, for example, during any user selected minute on a minute-by-minute real time simulated operating basis, for the purpose of periodically and/or spontaneously analyzing and reviewing event and/or scenario parameters affecting the simulated organizations and the associated simulated environment up to that selected minute. In particular, discussion breaks, monitored by a watch displayed on the viewing screens of users, can be set in advance to occur automatically at predefined periodic times or time intervals, or, can be spontaneously ordered during real time running of the simulator, in order for users to discuss, chat, and/or purchase consultation, relating to the status of the simulated organizations and environment, leading up to the pre-defined and/or spontaneously selected break. Various commands to be executed during real time operation of the simulator can be defined. For example, a decision, for eventual execution, made by a user is commanded in the background running of the simulator. Additionally, program parameters, for example, number of average orders received by the simulated organization, bankruptcy of a simulated competitor, customers requesting or sending orders to the simulated organization, can be defined for continued real time operation of the simulator.

Easy to use screen text customization: According to user commands, the simulator easily changes meaning of screen objects by changing names and descriptions of the screen objects. The simulator uses a special file, which contains all text elements of the screen objects. The simulator automatically replaces original texts displayed on a screen with strings defined in the file, thereby assigning different meanings to the screen objects. For example, a simulated production plant with machines producing end products is, by user command, instantaneously transformed into a simulated government office with clerks processing paperwork and producing reports.

Simulating sessions including multimedia: The simulator optionally attaches and plays various types of multimedia files during simulation sessions, thereby enhancing the training, learning, and/or entertainment, experience.

It is to be understood that the present invention is not limited in its application to the details of construction, arrangement, composition of the components, and order or sequence of steps of operation or implementation, set forth in the following description, drawings, or examples. For example, the following description refers to users training, learning, and/or being entertained, in a simulated competitive business environment, in order to illustrate implementation of the present invention. The present invention is capable of other embodiments or of being practiced or carried out in various ways. In particular, the method and system of the present invention, can in a straightforward manner be applied and extended to all kinds and types of industries, such as banking, insurance, retail, distribution, service companies, telecom companies, start ups, high-tech, Internet companies, sales forces training, financial services, aircraft companies, transportation, parcel delivery companies, aerospace, education organization, healthcare, hospitals, real estate, nonprofit and government offices, municipal offices, sport organizations, publishing companies, hotels, radio, and television. Also, it is to be understood that the phraseology and terminology employed herein are for the purpose of description and should not be regarded as limiting.

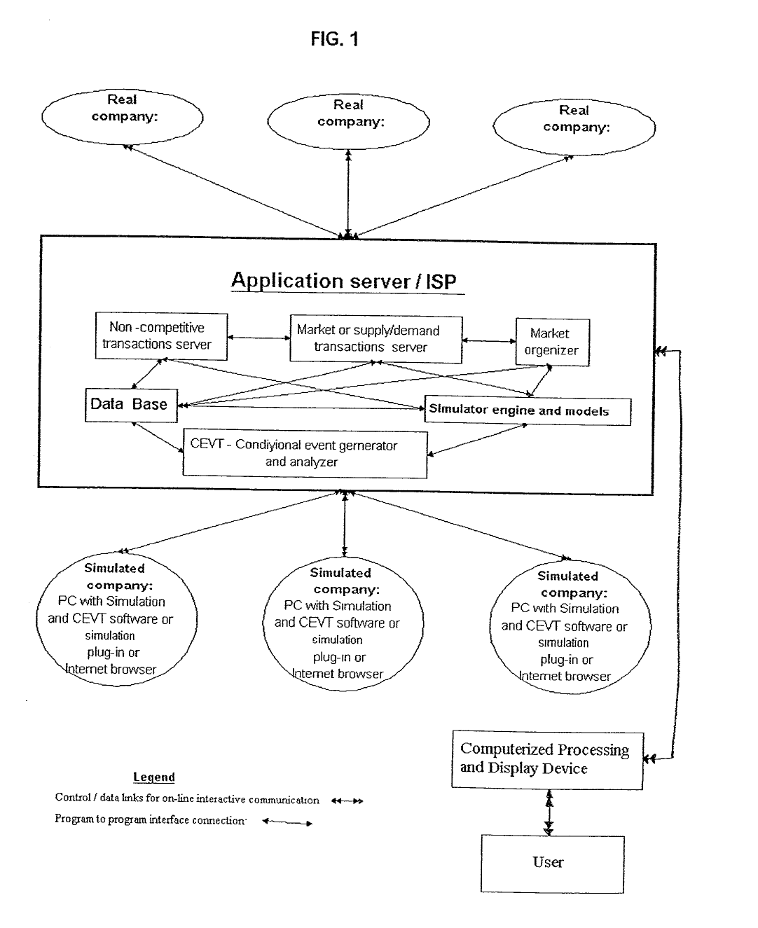

Steps, components, operation, and implementation of a method and system for using a software simulator featuring multi-scenario interactive competitive and non-competitive dynamics for training, learning, and entertainment, according to the present invention are better understood with reference to the following description and accompanying drawings. Terminology appearing in the following description is consistent with that used in FIGS. 1 through 4.

Referring now to the drawings, FIG. 1 is a schematic diagram illustrating exemplary preferred embodiments of the system for multi-scenario interactive competitive and non-competitive training, learning, and entertainment, using a software simulator featuring multi-scenario interactive competitive and non-competitive dynamics, in a single or multi-user, non-network or network environment.

The non-network embodiment of the system features the following primary components: (a) a software simulator featuring multi-scenario interactive competitive and non-competitive dynamics for the training, learning, and entertainment in the non-network environment; (b) at least one user for interactively and competitively/non-competitively operating at least one simulated organization generated by the software simulator in the non-network environment; (c) a computerized processing and display device such as a personal computer (PC) or a laptop computer, for hosting and operating the software simulator and for the at least one user to operate the software simulator in the non-network environment; and, (d) a database unit, associated with component (c), the computerized processing unit, featuring at least one database for hosting and saving different types of interactive, non-interactive, static, and/or dynamic, data and information associated with operating the software simulator in the non-network environment.

The network embodiment of the system features the following primary components: (a) a software simulator featuring multi-scenario interactive competitive and non-competitive dynamics for the training, learning, and entertainment in the multi-user network environment; (b) a plurality of at least two users for interactively and competitively/non-competitively operating a corresponding plurality of at least two simulated organizations generated by the software simulator in the multi-user network environment; (c) a corresponding plurality of computerized processing and display devices such as personal computers (PCs) or laptop computers, for locally hosting and operating the software simulator and for the corresponding plurality of at least two users to operate the software simulator in the multi-user network environment; (d) a database unit, associated with each computerized processing unit, featuring at least one database for locally hosting and saving different types of interactive, non-interactive, static, and/or dynamic, data and information associated with operating the software simulator; (e) a service provider including a server for providing and hosting the software simulator for the plurality of at least two users interactively and competitively/non-competitively operating a corresponding plurality of at least two simulated organizations generated by the software simulator in the multi-user network environment; and, (f) an electronic interactive multi-user communication network, such as an intranet of a business, or an extranet, for example, the world wide web Internet, as a mechanism for the users, the computerized processing and display devices, the database units, and the service provider to interactively communicate with each other.

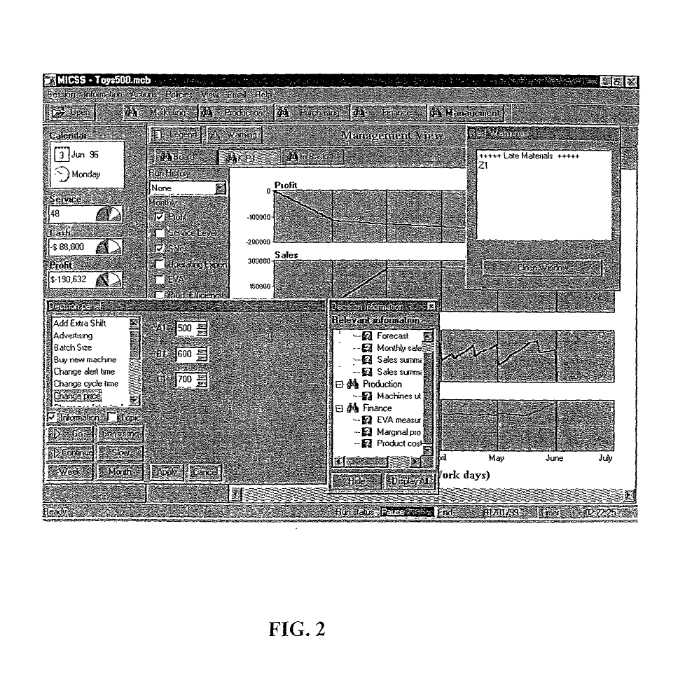

FIG. 2 is a graphical print-out of an exemplary preferred embodiment of a display screen showing various functions a user can select from for making various decisions and for checking relevant information related to the made decisions, by using the software simulator featuring multi-scenario interactive competitive and non-competitive dynamics for training, learning, and entertainment, as part of the system of the present invention shown in FIG. 1.

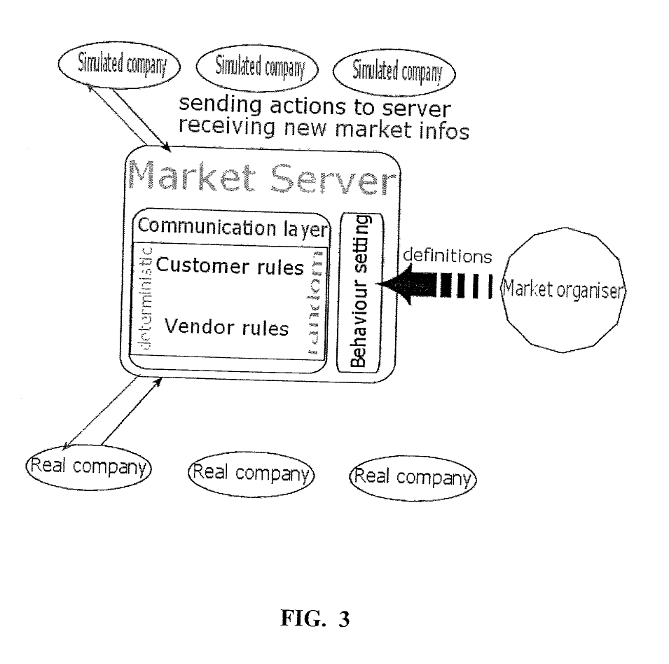

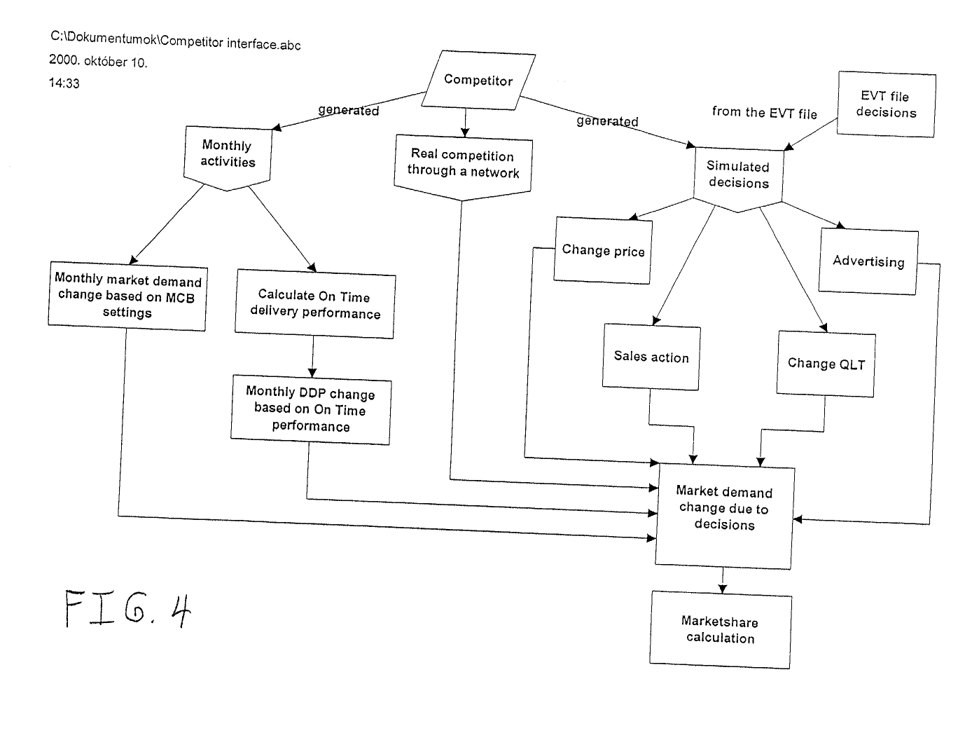

FIGS. 3 and 4 are schematic diagrams illustrating and highlighting exemplary preferred embodiments of the components, elements, and flow, of the multi-scenario interactive competitive and non-competitive dynamics, as part of the software simulator featuring multi-scenario interactive competitive and noncompetitive dynamics for training, learning, and entertainment, included in the system of the present invention shown in FIG. 1.

Referring to FIGS. 1-4, the preferred embodiment of the general method for operating and implementing above described non-network and network preferred embodiments of the system, featuring the indicated primary steps, is herein briefly described. An exemplary preferred embodiment of a conditional events (CEVT) logic associated with the software simulator, and, an exemplary preferred embodiment of a conditional events (CEVT) parameters file associated with the software simulator, are presented below in APPENDIX 1 and in APPENDIX 2, respectively, following the brief description of the general method of implementation.

In Step (a) of the general method of the present invention, there is providing a software simulator featuring multi-scenario interactive competitive and non-competitive dynamics for training, learning, and entertainment, to at least one user. Hereinafter, a user is defined as someone performing the training, learning, and/or entertainment, by implementing the software simulator and associated system of the present invention. For example, a user can be an employee of a company, such as a worker or a manager, or, a private individual implementing the invention in a setting separate from work. Each user works directly through in Internet browser, or, alternatively, downloads, either selected or entire parts of the software simulator either off-line, or, on-line by way of the electronic interactive multi-user communication network, such as by connecting to an appropriate web application and downloading the necessary software components of the software simulator.

In Step (b), there is activating, either locally off-line, or, on-line, the software simulator by each user.

In Step (c), there is operating a simulated organization for each user on a continuous basis.

In Step (d), there is initializing scenario events by the software simulator for generating various types of events, which are used for the training, learning, and entertainment, purposes as well as for the evolving scenario.

In Step (e), there is generating events, and, directions for training, learning, and entertainment, by the interactive and competitive/non-competitive simulated environment according to one of the following particular categories of multi-scenario interactive competitive/non-competitive dynamics:

(1) a single user interactively and competitively/non-competitively operating a simulated organization in a simulated environment characterized and affected by a set of simulated dynamically changing market or supply/demand parameters, (2) a plurality of users interactively and competitively/non-competitively operating a corresponding plurality of simulated organizations in a same simulated environment characterized and affected by a same set of simulated dynamically changing market or supply/demand parameters, and, (3) a first plurality of users interactively and competitively/non-competitively operating a corresponding first plurality of simulated organizations, and, a second plurality of users interactively and competitively/non-competitively operating a corresponding second plurality of simulated organizations, where the first plurality of users and the second plurality of users interactively and competitively/non-competitively operate in a same simulated environment characterized and affected by a same set of simulated dynamically changing market or supply/demand parameters. Each set of interactively dynamically changing market or supply/demand parameters includes and/or is associated with the simulated organizations, and, products and customers of the simulated organizations.

In category (1), there is software-simulated competition when the customers react, thereby causing dynamic changes in market demand. Events are generated, for example, number of average orders received by the simulated organization, bankruptcy of a simulated competitor, customers requesting or sending orders to the simulated organization, which directly affect and become associated with the multi-scenario interactive competitive/non-competitive dynamics for training, learning, and entertaining, while using the simulator.

In category (2), there is competition by different users, each of them running a simulated organization on a computerized processing and display device, whereby the multi-user decisions cause dynamic changing of market shares and demand levels and competition for same customers.

In category (3), there is the same competition as in categories (1) and (2), with the addition of having transactions of supplied purchased items being provided by other users that are producing for the orders placed by competing users. Purchased items are supplied by other users also interactively and competitively operating simulated organizations. The network of simulated supplier organizations, products, and customers, forms a multi-tier product/supply/customer chain, meaning that there are new competition tiers generated between the suppliers, suppliers of suppliers, and so on, according to initialization and pre-determined settings of the software simulator.

Accordingly, in Step (e), there is generating and operating of multi-scenario interactive competitive/non-competitive dynamics of each user operated simulated organization in a simulated environment characterized and affected by a set of interactively dynamically changing market or supply/demand parameters, including and/or associated with simulated organizations, and, products and customers of the simulated organizations.

In Step (f), there is responding to events by each simulated organization and by each user.

In Step (g), there is searching for correct information, correct decisions, and/or purchasing consultation, followed by responding, by each user.

In Step (h), there is a recording of events into a database by the software simulator, for replaying at a later time.

In Step (i), there is recording user performance and all other relevant data and information in the appropriate databases, whereby each user has access to the recorded user performance, and, other relevant data and information.

In Step (j), there is monitoring responses of each user and performance of each simulated organization by a conditional event generator of the software simulator (meaning the software simulator and database are capable of displaying pre-defined events and/or events which are generated on-the-fly by monitoring processes of various conditions), whereby the conditional event generator generates recommendations for (right or wrong) directions each user should take, according to pre-determined goals and schedule of a given simulation session.

APPENDIX 1 (attached) relates to an exemplary preferred embodiment of a conditional events (CEVT) logic associated with the software simulator featuring multi-scenario interactive competitive and non-competitive dynamics for training, learning, and entertainment, in a single or multi-user, non-network or network environment, in accordance with the present invention.

APPENDIX 2 (attached) relates to an exemplary preferred embodiment of a conditional events (CEVT) parameters file associated with the software simulator featuring multi-scenario interactive competitive and non-competitive dynamics for training, learning, and entertainment, in a single or multi-user, non-network or network environment, in accordance with the present invention.

For purposes of this specification and the accompanying claims, the phrase “data processing and display device” includes, but is not limited to a user client.

For purposes of ths specification and the accompanying claims the phrase “display device” refers to any device for presentation of data to a user. The definition includes, but is not limited to speakers, earphones, LCD screens, LED displays, CRT displays and active matrix displays.

For purposes of this specification and the accompanying claims, the phrase “channel of communication” refers to a telephone connection, a cellular telephone connection, an Internet connection, an infrared frequency transmission connection, a local area network connection, a radio frequency connection, a fiber-optic connection or a connection by a wire. Inherent in the idea of a communication channel is an open status during which data transmission may occur. In some cases, communication channels may also have a closed status during which no data transmission may occur.

For purposes of this specification and the accompanying claims, the phrase “user client” generally refers to a computer and includes, but is not limited to, personal computers (PC) having an operating system such as DOS, Windows™, OS/2™ or Linux; Macintosh™, Palm OS™, EPOC™ computers; computers having JAVA™-OS as the operating system; and graphical workstations such as the computers of Sun Microsystems™ and Silicon Graphics™, and other computers having some version of the UNIX operating system such as AIX™ or SOLARIS™ of Sun Microsystems™; or any other known and available operating system; personal digital assistants (PDA), cellular telephones having computer capabilities, a telephone having computer capabilities and Web TVs, each of which is known to include an inherent or connectable display device.

For purposes of this specification and the accompanying claims, the term “server” refers to any computing machine cabable of exchanging data with at least one other computing machine. A single server may comprise an individual computing machine or a plurality of such machines acting in concert to perm a function requested by at least one other computing machine.

For purposes of this specification and the accompanying claims, the term “Windows™” includes but is not limited to Windows 95™, Windows 2000™ Windows 3.x™ in which “x” is an integer such as “1”, Windows NT™, Windows 98™, Windows CE™ Windows ME™, Windows XP™ and any upgraded versions of these operating systems by Microsoft Corp (USA) and/or window managers for the graphical X Windows system for UNIX based operating systems and/or its variants such as Linux.

For purposes of this specification and the accompanying claims, the phrase “Graphical user interface” or “GUI” includes, but is not limited to, a “Web browser”

For purposes of this specification and the accompanying claims, the phrase “Web browser” or “browser”, unless otherwise indicated, refers to any software program which can display text, graphics, or both, as well as display video, and/or play sounds, from Web pages on World Wide Web sites and or local files.

For purposes of this specification and the accompanying claims, the phrase “Web page” refers to any document written in a “mark-up language”, or “script language”, or any programming language or tool. For purposes of this specification and the accompanying claims, the phrase “mark up language” includes, but is not limited to, HTML (hypertext mark-up language) or VRML (virtual reality modeling language), dynamic HTML, XML (extended mark-up language) or related computer languages thereof, as well as to any collection of such documents reachable through one specific Internet address or at one specific World Wide Web site, or any document obtainable through a particular URL (Uniform Resource Locator). Script languages include, but are not limited to, CGI, PERL, VBScript, JavaScript, ASP.

While the invention has been described in conjunction with specific embodiments, examples, and appendices, thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A system for multi-scenario interactive training, learning, and entertainment, the system comprising:
(a) at least one user operating at least one data processing and display device designed and configured to operate a software simulator which simulates operation of at least one simulated organization generated by said software simulator; and
(b) a database containing data and information associated with operating said software simulator;
wherein operation of at least one of said at least one simulated organization is in response to data supplied to said database by said at least one user.

2. The system of claim 1, further comprising:
(c) a remote server capable of communication with said at least one data processing and display device; and
(d) a channel of communication capable of facilitating data transfer between said server and said at least one data processing and display device.

3. The system of claim 2, wherein said channel of communication includes at least one item selected from the group consisting of a telephone connection, a cellular telephone connection, an Internet connection, an infrared frequency transmission connection, a local area network connection, a radio frequency connection, a fiber-optic connection or a connection by a wire

4. The system of claim 1, wherein said database includes data used by said software simulator in generation of multi-scenario interactive dynamics for training, learning and entertainment.

5. The system of claim 2, wherein said at least one user includes at least two users, each of said at least two users operating said software simulator interactively.

6. The system of claim 5, wherein operating said software simulator interactively indicates competition among said at least two users.

7. The system of claim 5, wherein said at least two users are interactively connected and allowed to engage in an industry level of cooperation according to rules and conventions of business.

8. The system of claim 7, wherein said cooperation includes at least one item selected from the group consisting of business-to-business (B2B) and business-to-customer (B2C) relationships.

9. The system of claim 1, wherein said software simulator is further designed and configured to provide each of said at least one user with at least one item selected from the group consisting of information items relevant to a decision selected from a list, information items relevant to a topic selected from a list and available decisions.

10. The system of claim 1, wherein said software simulator is further designed and configured to generate events from data in said database.

11. The system of claim 1, wherein said software simulator is further designed and configured to generate scenarios from data in said database.

12. The system of claim 1, wherein said software simulator is further designed and configured to provide active guidance for said user, said guidance serving to direct said user towards improved performance, wherein said guidance is based upon data supplied to said database by said user and results thereof.

13. The system of claim 1, wherein said software simulator is further designed and configured to generate summaries of results of data input to said database by said at least one user.

14. The system of claim 1, wherein said software simulator is further designed and configured to generate a history of data and information relating to data input to said database by said at least one user in a format selected from the group consisting of a tabular format and a graphical format.

15. The system of claim 14, wherein said software simulator is further designed and configured to save simulation sessions as files.

16. The system of claim 15, wherein said software simulator is further designed and configured to replay said files.

17. The system of claim 14, wherein said software simulator is further designed and configured to compare at least two of said files.

18. The system of claim 2, wherein said database resides in a location selected from the group consisting of said at least one data processing and display device, said remote server and a combination thereof.

19. A method for multi-scenario interactive training, learning, and entertainment, the method comprising:
(a) providing data from a database to a software simulator which simulates operation of at least one simulated organization generated by said software simulator in order to generate a first event which requires a first response;
(b) allowing at least one user operating at least one data processing and display device designed and configured to operate said software simulator to input said first response to said database;
(c) providing additional data from said database to said software simulator in order to generate a second event which requires a second response;
wherein said first response determines which additional data is chosen by said software simulator; and
(d) recording said first and second responses of said at least one user in said database for analysis.

20. The method of claim 19, further comprising:
(e) analyzing said responses in said database as a means of assessing managerial skills of said user.

21. The method of claim 19, further including cyclic repletion of steps a-d.

22. The method of claim 19, further comprising:
(e) transferring data between a remote server containing at least a portion of said database and said at least one data processing and display device.

23. The method of claim 19, wherein said providing data includes concurrent provision of data from said database to a software simulator which simulates operation of a plurality of simulated organizations in order to generate a first event which requires a first response from a plurality of users operating a plurality of data processing and display devices such that said plurality of users concurrently participate in simulated events.

24. The method of claim 23, wherein said plurality of users operating said plurality of data processing and display devices engage in active competition.

25. The method of claim 23, further comprising providing to each of said plurality of users, access to responses accumulated in said database

26. The method of claim 19, further comprising:
(e) monitoring of said responses of said at least one user and a performance of said simulated organization by said software simulator; and
(f) generating at least one recommendation to aid said at least one user in achieving a goal;
(g) providing said at least one recommendation to said user.

27. The method of claim 23, wherein each of said plurality of users is capable of communicating with any other members of said plurality directly.

28. The method of claim 27, wherein said communicating is conducted via a method selected from the group consisting of a chat room and a virtual community.
